(19) United States
(12) Patent Application Publication
(10) Pub. No.: US 2024/0059590 A1
(43) Pub. Date: Feb. 22, 2024

(54) Method for Treating Organic Compounds from Industrial Wastewater with Resins

(71) Applicant: Veolia Environnement, Paris (FR)

(72) Inventors: Romain Gandre, Paris (FR); Bi Chen, Hangzhou Zhejiang (CN)

(21) Appl. No.: 18/270,137

(22) PCT Filed: Dec. 31, 2020
(86) PCT No.: PCT/CN2020/142215

§ 371 Date: Jun. 28, 2023

(51) Int. Cl. C02F 1/42; C02F 1/44; B01J 41/05; B01J 41/14; B01J 49/57; B01J 49/07

(52) U.S. Cl. CPC C02F 1/42; C02F 1/441; B01J 41/05; B01J 41/14; B01J 49/57; B01J 49/07; C02F 2303/16; C02F 2001/422; C02F 2103/365

(57) ABSTRACT

Method implementing resins for treating organic compounds in industrial wastewaters, said method comprising the steps of: during treatment cycles, pumping an industrial wastewater into a reactor containing an ion-exchange resin, letting said organic compounds being captured onto said resin and obtaining a treated wastewater at an outlet of said reactor; during regeneration cycles for restoring removal capacity of said resin, stopping said pumping of said industrial wastewater into said reactor, pumping a regeneration liquid into said reactor, letting said regeneration liquid desorb the organic compounds captured onto the resin, and obtaining an eluate containing said desorbed organic matter; recycling said eluate for using it as said regeneration liquid, characterized in that said resin is a strong base anionic ion exchange resin, and said regeneration liquid is an hypersaline solution.

### FIELD OF THE INVENTION

The present invention relates to a method for treating organic compounds in industrial wastewaters implementing resins.

### PRIOR ART

Industrial wastewaters, such as for example wastewaters produced by the petrochemical or steel industries, contain pollutants and must be treated before being reused or disposed of. Most of said industrial wastewaters contain pollutants which are organic compounds.

The pollution of industrial wastewaters is commonly stated in terms of its chemical oxygen demand (COD) content. The aim of industrial wastewater treatments is to lower this COD content so as to make the treated wastewater able to be re-used or released in the environment.

Conventional treatments of wastewater may include oxidation steps implementing biomass operating in reactors or basins. Such biological treatments may remove at least a part of the organic matters contained in said wastewater. Nonetheless, industrial wastewaters often contain some organic matters which are not affected by such biological treatments. These non-biodegradable matters are mostly soluble. Such organic matters, which are often qualified as “refractory organic matters” or “hard COD”, must thus be treated by implementing oxidation conditions that are stronger than the oxidation conditions of biological treatments, such as for example advanced oxidation processes. Alternatively, these refractory organic matters may be physically retained from the wastewaters by using membranes or by using adsorption.

An adsorption technology widely reported for the treatment of the industrial wastewaters is based on the use of activated carbon (AC). Such activated carbon may be used in the form of Granular Activated Carbon (GAC) packed in fixed bed filters or in the form of Powdered Activated Carbon (PAC) in fluidized bed or continuous stirred-tank reactors.

These treatments implementing activated carbon have the disadvantage to require high usage rates of activated carbon. When PAC is used, important quantities of sludge are produced. A part of the PAC contained in these sludges can be extracted in the aim to be reused, but the amount of sludge to be disposed of remains high. As no technology is known to date to regenerate AC in-situ at industrial scale, a very frequent change-out of the AC media must be made when this material is used. Such high using rates of the activated carbon render these technologies expensive.

Another adsorption technology widely reported for the treatment of refractory organic matters in industrial wastewaters is based on the use of adsorption resins. Such resins are known and commercialized for their high adsorption capacities. They may be used in packed bed columns as well as in fluidized bed reactors. These resins are made of beads of reticulated or condensed polymer showing a very high surface area and forming pores. When contacting the wastewater with such resins the organic molecules of the same are captured. The mechanism involved is mainly based on hydrophobic interactions which can occur as well in the pores as at the surface of the resin.

After a certain time of use, the resins can be regenerated in-situ by using regeneration solutions. These solutions are contacted with the resin during a sufficient time to desorb the matters adsorbed on it. The obtained spent solutions, commonly called eluate, may be used for several regeneration cycles. Then, the eluate is either discarded or preferably treated in order to eliminate the pollutants that it contains in the aim of reusing it in further regeneration cycles.

Such regeneration solutions are either solutions containing organic solvents such as methanol, acetone, isopropanol or solutions having an extreme pH such as solutions containing caustic soda or hydrochloric acid. These regeneration solutions are able to desorb the organic matters captured by the resins.

One disadvantage of such techniques is that the costs involved by the making of these solutions are high compared to those involved by the making of chloride or sulfate salt solutions such as NaCl or KCl or Na₂SO₄ solutions.

Another disadvantage is that the costs for treating such regeneration solutions are rather high because they need equipment and methods designed for organic solvents or extreme pH. Consequently, it may be not cost-effective to treat these solutions to reuse the same over several regeneration cycles. Thus, the volumes of rejected eluates may be high.

Another disadvantage of these techniques is that the eluates are harmful for the environment and must be treated before being discarded. Such treatments increase the total cost of the whole process.

Consequently, there is a need for more cost effective and more environmentally-friendly alternative technical solutions for the removal of organic compounds from industrial wastewaters, including the organic compounds which are difficult to remove by biological treatment.

### DISCLOSURE OF THE INVENTION

The present invention relates to a method implementing resins for treating organic compounds in industrial wastewaters, said method comprising the steps of:
during treatment cycles, pumping an industrial wastewater into a reactor containing an ion-exchange resin, letting said organic compounds being captured onto said resin and obtaining a treated wastewater at an outlet of said reactor;
during regeneration cycles for restoring removal capacity of said resin, stopping said pumping of said industrial wastewater into said reactor, pumping a regeneration liquid into said reactor, letting said regeneration liquid desorb the organic compounds captured onto the resin, and obtaining an eluate containing said desorbed organic matter;
recycling said eluate for using it as said regeneration liquid, characterized in that said resin is a strong base anionic ion exchange resin, and said regeneration liquid is an hypersaline solution.

The invention is particularly adapted for treating refractory organic compounds. Refractory organic compounds are dissolved organic matters which could not be removed by any type of biological treatment known by the person skilled in the art, thereby including aerobic biological treatment, anoxic biological treatment, anaerobic biological treatment, whether such biological treatment be performed at different levels of temperature (psychrophilic bacteria, mesophilic bacteria, thermophilic bacteria, extreme thermophilic bacteria), different levels of salinity (halophilic bacteria), different of levels of pH (acidophilic bacteria, alkaliphilic bacteria), or different levels of pressure (barophilic).

According to the invention, ion-exchange resins are used in place of adsorbent resins to retain the organic matters contained in the industrial wastewaters. The resins used in the invention are non-magnetic.

On the market of resins, ion-exchange resins and adsorbent resins are proposed as different kinds of product.

Ion-exchange resins are made of micro-beads of cross-reticulated or condensed polymer on which ion-exchange functional groups (R—HCO₂⁻, R—HSO₃⁻, R—NH₃⁺ . . . ) are grafted and receive counter-ions. These counter-ions are either anions, the corresponding resins being conventionally named anionic resins, or cations, the corresponding resins being conventionally named cationic resins. The strength of the functional groups grafted on the cross-reticulated or condensed polymer defines on the market four main categories of ion-exchange resins: strong basic, strong acidic, weakly basic and weakly acidic.

These ion-exchange resins are designed and used for retaining compounds or molecules having a net electrical charge (such as anions or cations) which are contained in different types of liquids containing ionic compounds (bulk ions), in order to purify said liquids from said compounds. When passing the liquid on the ion-exchange resin, the resin exchanges its counter-ions against the bulk ions contained in said liquid. The compounds or molecules of said liquid are thus retained on the resins and a purified liquid is obtained at the outlet of the reactor containing the same.

In the field of water treatment, ion-exchange resins are commonly used in the installations for producing water for human consumption.

For example, they are used in the aim of softening water obtained during the process for producing potable water. When the water to soften is contacted with some ion-exchange resins during a sufficient time, the calcium and magnesium ions contained in the water corresponding to the hardness of the water are exchanged with the sodium ions present on the ion-exchange sites of the resin. In such a way, the calcium and magnesium ions of the water, which otherwise will combine with the carbonates of the same to give insoluble calcium or magnesium carbonates, are replaced by sodium ions which are more soluble in water.

Ion-exchange resins are also used to remove heavy metals from waters.

Magnetic ion-exchange resins are also used for reducing the concentrations of organic matters which may be present in surface waters from which potable water is made. Actually, such organic matters are essentially humic matters. Humic matters have a net electrical charge which make relevant the use of ion-exchange resins to retain them from the raw water.

These ion-exchange resins may be easily regenerated by using ionic solutions containing the counter-ions originally present on the resins. Such ionic solutions may be reused a great number of times until they are saturated. Consequently, the quantities of finally rejected liquid are low. These finally rejected effluents may be treated with conventional methods. The use of strong acidic or basic solutions is only needed when the pores of ion-exchange resins are deeply clogged in order to desorb the clogging materials without damaging the resin. For these reasons, the regeneration of ion-exchange resins is considered as far less harmful for the environment than the regeneration of adsorbent resins utilizing organic solvents.

Considering industrial wastewaters, the use of ion-exchange resins in the aim of eliminating the said organic matters according to the invention was not obvious because said organic matters do not show apparent electrical charges.

Actually, the inventors have observed that, despite the fact that the resins they used are ion-exchange resins, an adsorption of these organic compounds occurs on these resins rather than an exchange of ions. More surprisingly, hypersaline solutions happen to be efficient to desorb the organic compounds adsorbed on the resin, which was unexpected since these organic compounds are adsorbed on the resin and not linked to the resin through the same mechanism as that of an actual exchange of ions.

Compared to the method of the prior art using regeneration solutions which are either solutions containing organics solvents such as methanol, acetone, isopropanol or solutions having an extreme pH such as solutions containing caustic soda or hydrochloric acid, the present invention allows a lower consumption of chemicals.

The method according to the invention has also the advantage to be friendlier with the environment since the hypersaline regeneration liquids can be reused to regenerate the resins a certain number of times before requiring the discharge or the further treatment of the resulting solution called the spent eluate.

Preferably, the method according to the invention further comprises the steps of periodically filtering said spent eluate on at least one separation technology producing a concentrate containing organic compounds and multivalent ionic compounds, and a permeate containing monovalent ionic compounds, and recycling said permeate as at least a part of said regeneration liquid.

The filtering on at least one separation technology of said spent eluate is preferably carried out either when the eluate has been recycled a predetermined number of times.

The separation technology is preferably chosen amongst nanofiltration membrane technologies, low-pressure reverse osmosis membrane technologies, and electrodialysis with monovalent/multivalent selective ion exchange membranes technologies.

The separation technology optional step carried out in order to retain the pollutants from the spent eluate obtained at the outlet of the reactor may be effective for the reuse of the regeneration hypersaline solution during several regeneration cycles without involving high costs. The quantities of rejected eluates are thus smaller than those obtained in the conventional methods for regenerating adsorbent resins.

According to a preferred embodiment of the invention, the proposed method includes a further step of treating the concentrate produced by at least one separation technology to degrade the organic matters it contains and further concentrate said concentrate.

Preferably, this further step is an evaporative concentration.

Different hypersaline solutions may be used as regeneration solutions of the strong basic anionic resin used in the method according to the invention.

Preferably, said hypersaline solution is chosen amongst chloride salt solutions and sulphate salt solutions.

More preferably, said hypersaline solution is a sodium chloride solution at a concentration of 50 g NaCl/L to 300 g NaCl/L, preferably, of 120 g NaCl/L to 300 g NaCl/L.

It will be noted that sodium chloride solutions are commonly used as regeneration liquids to regenerate strong basic anionic resins. However, they are generally used at some concentrations which are lower than the above-mentioned concentrations preferably used in the present invention.

The method according to the invention may be implemented with different types of reactors containing the resin such as a fixed bed reactor, a fluidized bed reactor, or a continuous stirred tank reactor.

When the invention is carried out with a fixed bed configuration, the step of pumping the industrial water into said reactor containing said resin is carried out at a hydraulic load between 2 and 20 BV/h. BV are units which are commonly used in the state of the art and correspond to the ratio between the volume (m³) of effluent and the volume (m³) of resin installed in the reactor.

When the invention is carried out with a fluidized bed configuration, the step of pumping the industrial water into said reactor containing said resin is carried out at a fluidization rate between 0.4 m/h and 20 m/h, allowing a hydraulic residence time in said reactor between 3 minutes and 30 minutes, and a concentration of the said resin in the fluidized bed between 100 liters of resin per cubic meter of water and 500 liters of resin per cubic meter of water.

When the invention is carried out with a continuous stirred tank reactor, the step of pumping the industrial water into said reactor containing said resin is carried out so as to allow a hydraulic residence time in said reactor between 3 minutes and 30 minutes, and at a concentration of the said resin in said reactor between 0.1 liter of resin per cubic meter of water and 300 liters of resin per cubic of water.

### LIST OF FIGURES

A description of a preferred embodiment of the invention is made here after in reference to:

FIG. 1 which is a process scheme diagram showing the operation units 2, 7, 10 and process flows of an industrial wastewater 1 being treated by a method according to the invention; and,

FIG. 2 which is a graph showing the variation of amounts of COD of a petrochemical wastewater being treated by a method according to the invention at a laboratory scale and in a pilot unit; and,

FIG. 3 which is a graph showing the variation of amounts of counter and bulk anions in said wastewater during the implementation of the invention in said pilot unit.

### EMBODIMENT

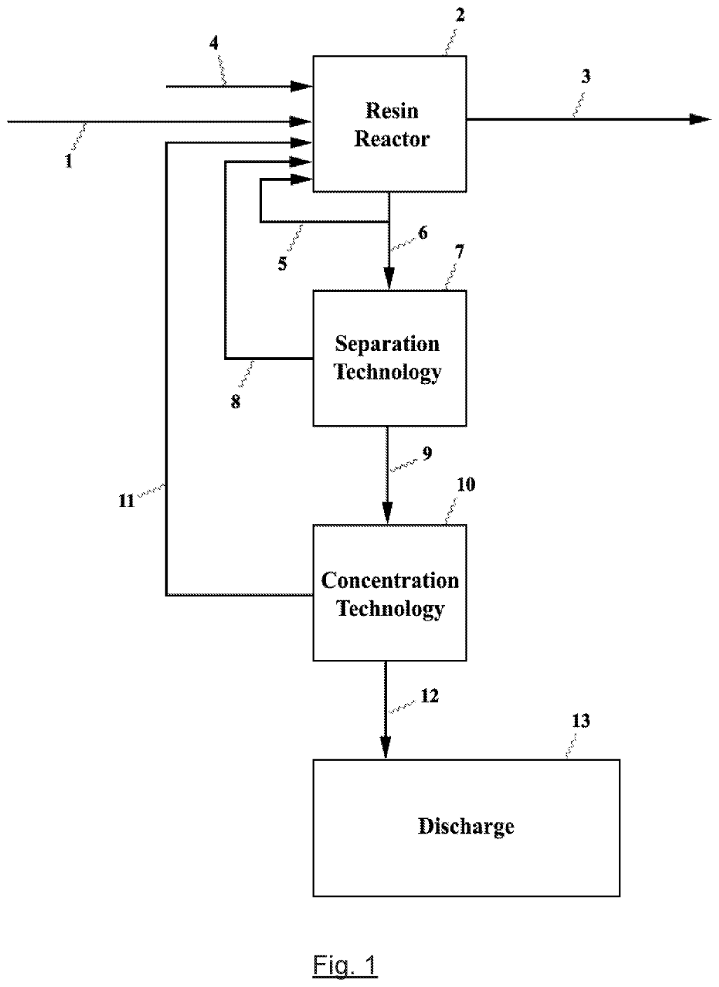

In reference to FIG. 1, an effluent issued from a petrochemical industry 1 consisting of a concentrate coming from reverse osmosis units has been treated with the method according to the present invention. This effluent shows a Chemical Oxygen Demand around 50 mg O₂/l.

In this embodiment, the ion-exchange strong basic anionic resin whose physical characteristics are summarized in the below table has been used. This resin shows quaternary ammonium groups grafted on a polyacrylic polymer reticulated with divinylbenzene and chloride ions (Cl⁻) as counter anions.

TABLE 1

| | | |
|---|---|---|
| Total Capacity | 0.8 | eq/L |
| Moisture Retention | 66 - 72% | (Cl— form) |
| Particle size range | 425 - 1200 | μm |

| | |
|---|---|
| Uniformity Coefficient (max.) | 1.6 |
| Reversible swelling Cl— → HO— (max.) | 20% |
| Specific Gravity | 1.08 |

This resin has been used as packed beds in two columns: tests have been carried out, PGP at a laboratory scale on a mini-column having a height of 1 m of resin and a diameter of 27 mm, and at a pilot scale on a column having a height of 1 m of resin and a diameter of 500 mm, by passing from top to bottom the above mentioned wastewater having a COD around 50 mg O₂/l.

The operating conditions were the same for both scales. Both lab-scale and pilot-scale columns were operated in parallel with the same hydraulic loads and fed with the same effluent.

The tests were carried out over three cycles.

During the first and third cycles, a hydraulic load of 5 BV/h was used and during the second cycle, a hydraulic load of 10 BV/h was used.

First Cycle

Both columns 2 were fed with the effluent 1 during 17 hours. The treated effluent 3 obtained at the outlets of each column was collected and its COD content constantly measured.

At the end of the first cycle, the feeding of the columns with effluent 1 was stopped.

The regeneration of the resin of each column was then performed with an hypersaline solution 4 at 160 g NaCl/L at a regeneration rate of 480 g NaCl/L of the resin installed, by passing from top to bottom the regeneration solution 4 through each column 2 with a contact time of 15 minutes (hydraulic load of 4 BV/h). The resulting eluate 5 was collected.

The feeding of the columns 2 with effluent 1 was then started again for a second cycle.

Second Cycle

Both columns 2 were fed with the effluent 1 during 4 hours. The treated effluent 3 obtained at the outlet of each column 2 was collected and its COD content constantly measured.

At the end of the second cycle, the feeding of the columns 2 with the effluent 1 was stopped and the regeneration of the resin of each column 2 was performed by passing from top to bottom 100% of the volume of the eluate 5 collected at the end of the first cycle respectively through each column 2 with a contact time of 15 minutes (hydraulic load of 4 BV/h).

The alimentation of the columns 2 with effluent 1 was then started again for a third cycle.

Third Cycle

Both columns 2 were fed with the effluent 1 during 18 hours. The treated effluent 3 obtained at the outlet of each column 2 was collected and its COD content constantly measured.

At the end of the third cycle, the alimentation of the columns 2 with the effluent 1 was stopped and the regeneration of the resin of each column 2 was performed by passing 100% of the volume of the eluate 5 collected at the end of the first cycle through each column with a contact time of 15 minutes (hydraulic load of 4 BV/h).

The resulting spent eluate 6 was collected and submitted to a membrane filtration 7, whose specifications are listed in the below table, in order to separate a permeate 8 containing monovalent sodium and chloride ions and a concentrate 9 containing organic compounds and multivalent ions.

TABLE 2

| Active Area | 82 ft² (7.6 m²) |
|---|---|
| Applied Pressure | 70 psig (4.8 bars) |
| Permeate Flow Rate | 2500 gpd (9.5 m3/d) |
| Stabilized Salt rejection | >97% |

Permeate flow and salt rejection based on the following test conditions: 2,000 ppm MgSO₄, 25° C. (77° F.) and 15% recovery at the pressure specified above.

The treated spent eluate (permeate) 8 was collected. It could have been used for further regeneration cycles.

The concentrate 9 was submitted to an evaporative concentration 10 for lowering the volume of polluted liquid to be discarded, producing a highly-organics-concentrated liquor 12 to be discharged in 13, and a clean condensate 11 which could have been used for preparation of the regeneration solution.

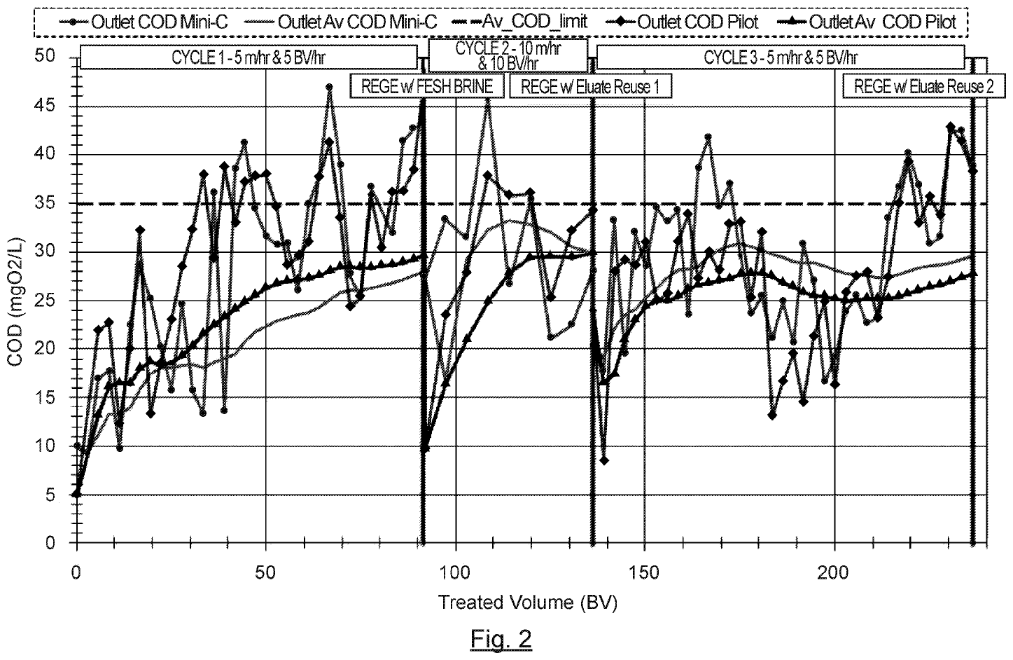

During the three cycles, the COD concentration of the treated effluent 3 exiting each column was constantly measured and averaged. Results of these measurements are reported on FIG. 2 which is a graph showing the evolutions of these concentrations during the three cycles.

COD of the effluent 3 at the outlet of each column was compared to the COD content of the effluent 1 provided at the inlet of the column. The average COD removal rate was calculated for each column 2 at the end of each cycle.

The capacity of the resin of each column 2 for retaining COD and sulphates was checked at the end of each cycle.

The results of these tests are indicated in table 1 below.

TABLE 3

| | Cycle 1 | Cycle 2 | Cycle 3 |
|---|---|---|---|
| | (5 m/h) | (10 m/h) | (5 m/h) |
| Running time (h) | 17 | 4 | 18 |
| Volume of wastewater | 83 | 40 | 90 |
| treated (BV) | | | |
| COD mg O₂/l at the inlet of | 48 | 53 | 48 |
| the column (average over | | | |
| the cycle) | | | |
| COD mg O₂/l at the outlet | 29.6 | 29.9 | 27.7 |
| of the column of the pilot | | | |
| (average over the cycle) | | | |
| Average COD removal in | 38 | 44 | 42 |
| the pilot (%) | | | |
| Resin capacity of the pilot | 2.5 | 1.6 | 2.9 |
| (g COD / Liter of Resin) | | | |
| Resin capacity of the pilot | 50 | 45 | 44 |
| (g SO₄/Liter of Resin) | | | |
| COD mg O₂/l at the outlet | 28.1 | 29.9 | 29.6 |
| of the mini-column | | | |
| Average COD removal in | 41 | 44 | 38 |
| the mini-column (%) | | | |
| Resin capacity of the | 3.0 | 1.7 | 2.8 |
| micro-column (g COD/ | | | |
| Litter of Resin) | | | |
| Resin capacity of the mini- | 46 | 56 | 47 |
| column (g SO₄/Liter of | | | |
| Resin) | | | |

These results show that 38% of the COD of the petrochemical effluent 1 was removed during the first cycle, 44% during the second cycle and 42% during the third cycle (averages calculated with the COD content of the batch of effluent treated 3 during each said whole cycle).

Capacities of the resin to retain COD and exchange anions were essentially maintained during the three cycles.

These results show the high performances of the method according to the invention with high average COD removal. These results also evidence that these performances can be maintained over the time.

During the three cycles carried out on the column of the pilot unit 2, the concentrations of chloride counter-ions chloride (Cl⁻) and sulphate anions (SO4⁻) entering and exiting the column have been constantly measured.

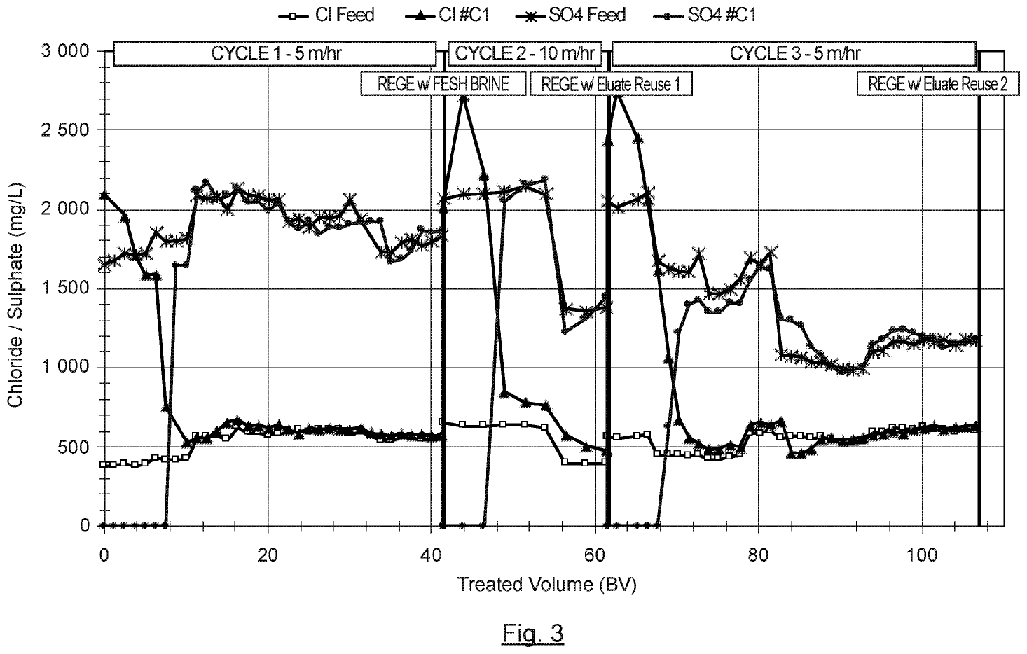

Results of these measurements are reported on FIG. 3.

On reference to this FIG. 3, it can be seen that, at the beginning of the first cycle, an exchange shortly, and exclusively, happens between the chloride ions present on the resin (counter-ions) and the bulk anions (sulphates) present in the effluent 1. Quickly, when the treated volume 3 reaches around 11 BV, the corresponding curves of counter-ion Cl⁻ and bulk anion SO4⁻ measured at the inlet 1 and the outlet 3 of the column of the pilot overlay which means that no release of chloride is reported, neither exchange of sulphates onto the resins. The exclusiveness nature of the exchange between the chloride and the sulphates is confirmed when expressing this exchange with the equivalent charges of said anions. One (1) equivalent represents one (1) mole of electric charge and is calculated by multiplying the number of moles of charged particles in a substance by the valence of that substance. During this first cycle, the amount of chloride released fully equals the amount of sulphates captured during the exchange mechanism, evidencing thus this exclusiveness.

This observation was also made for second and third cycles.

In the meantime, and along the rest of the cycle, the organic compounds are still removed at a high rate as can be seen of FIG. 2.

These results evidenced that the mechanism at stake in the invention is an adsorption mechanism and not an ion-exchange one.

Adsorption mechanisms allow the high performances and the robustness of the method according to the invention by making it economically viable, particularly by allowing a greater number of regeneration cycles due to the fact that the regeneration solutions 4 are hypersaline solutions and not solvent or extreme pH solutions, and by getting a significantly higher removal capacity toward the organic compounds.

Comparatively to the regeneration solutions commonly used to desorb components adsorbed onto adsorbent resins, such as NaOH, methanol, ethanol, acetone . . . the hypersaline solution 4 used in the present invention implies very good regeneration performances and is less harmful to the environment.

1-13. (canceled)

14. Method implementing resins for treating refractory organic compounds, i.e. compounds which are not affected by biological treatments, in industrial wastewaters, said method comprising the steps of:
during treatment cycles, pumping an industrial wastewater into a reactor containing an ion-exchange resin, letting said organic compounds being captured onto said resin and obtaining a treated wastewater at an outlet of said reactor;
during regeneration cycles for restoring removal capacity of said resin, stopping said pumping of said industrial wastewater into said reactor, pumping a regeneration liquid into said reactor, letting said regeneration liquid desorb the organic compounds captured onto the resin, and obtaining an eluate containing said desorbed organic matter;
recycling said eluate for using it as said regeneration liquid,
characterized in that said resin is a strong base anionic ion exchange resin, and said regeneration liquid is a hypersaline solution.

15. Method according to claim 14 characterized in that said method further comprises the steps of periodically filtering said eluate on at least one separation technology producing a concentrate containing organic compounds and multivalent ionic compounds and a permeate containing monovalent ionic compounds, and recycling said permeate as at least a part of said regeneration liquid.

16. Method according to claim 15 characterized in that said filtering on at least one separation technology of said eluate is carried out when said eluate has been reused a predetermined number of times.

17. Method according to claim 16 characterized in that said separation technology is chosen amongst nanofiltration membrane technologies, low-pressure reverse osmosis membrane technologies, and electrodialysis with monovalent/multivalent selective ion exchange membrane technologies.

18. Method according to claim 15 characterized in that it includes a step of treating said concentrate produced by said at least separation technology to degrade the organic matters it contains and further concentrate said concentrate.

19. Method according to claim 18 characterized in that said step of treating said concentrate is an evaporative concentration.

20. Method according to claim 14 characterized in that said hypersaline solution is chosen amongst chloride salt solutions and sulphate salt solutions.

21. Method according to claim 20 characterized in said hypersaline solution is a sodium chloride solution at a concentration of 50 g NaCl/L to 300 g NaCl/L.

22. Method according to claim 20 characterized in said hypersaline solution is a sodium chloride solution at a concentration of 120 g NaCl/L to 300 g NaCl/L.

23. Method according to claim 14 characterized in that said reactor containing said resin is chosen in the group including fixed bed reactors, fluidized bed reactors and continuous stirred tank reactors.

24. Method according to claim 23 characterized in that the step of pumping the industrial water into said fixed bed reactor containing said resin is carried out at a hydraulic load between 2 and 10 BV/h.

25. Method according to claim 23 characterized in that the step of pumping the industrial wastewater into said fluidized bed reactor containing said resin is carried out at a fluidization rate between 0.4 m/h and 20 m/h, allowing a hydraulic residence time in said reactor between 3 minutes and 30 minutes, and a concentration of the said resin in the fluidized bed between 100 liters of resin per cubic meter of water and 500 liters of resin per cubic meter of water.

26. Method according to claim 23 characterized in that the step of pumping the industrial wastewater into said continuous stirred tank reactor containing said resin is carried out so as to allow a hydraulic residence time in said reactor between 3 minutes and 30 minutes, and at a concentration of the said resin in said reactor between 0.1 liter of resin per cubic meter of water and 300 liters of resin per cubic meter of water.

27. A process for treating industrial wastewater including a treatment mode and a resin regeneration mode, the process comprising:
(a) in the treatment mode, the process including:
(i) containing a strong base anionic ion exchange resin in a reactor;
(ii) directing the industrial wastewater into the reactor;
(iii) the industrial wastewater containing refractory dissolved organic compounds that are not generally susceptible to being removed from the wastewater by biological treatment;
(iv) desorbing the refractory organic compounds in the wastewater onto the strong base anionic ion exchange resin to produce treated wastewater;
(v) discharging the treated wastewater from the reactor;
(vi) ceasing the treatment mode;
(b) in the resin regeneration mode, the process includes:
(i) after ceasing the treatment mode, regenerating the strong base anionic ion exchange resin by directing a hypersaline solution into the reactor;
(ii) desorbing the refractory organic compounds associated with the strong base anionic ion exchange resin onto the hypersaline solution to yield an eluate containing the desorbed refractory organic compounds; and
(iii) recycling the eluate through the reactor and desorbing the refractory organic compounds from the strong base anionic ion exchange resin.

28. The process of claim 27 further including directing at least a portion of the eluate to a membrane separation unit and subjecting the eluate to a separation process that produces a concentrate containing refractory organic compounds and a permeate, and directing the permeate through the reactor where the permeate assists in desorbing refractory organic compounds from the resin.

29. The process of claim 28 wherein the eluate is subject to the separation process only after the eluate has circulated multiple times through the reactor.

30. The process of claim 27 wherein the reactor is a fluid bed reactor containing the resin and wherein the process includes a fluidization rate between 0.4 m/h and 20 m/h that produces a hydraulic residence time in the reactor between 3 minutes and 30 minutes, and a concentration of said resin in the fluidized bed between 100 liters of resin per cubic meter of wastewater and 500 liters of resin per cubic meter of wastewater.

31. The process of claim 27 wherein the reactor comprises a continuous stirred tank reactor containing resin and wherein the process provides a hydraulic residence time in the reactor between 3 minutes and 30 minutes, and at a concentration of said resin in the reactor between 0.1 liter of resin per cubic meter of wastewater and 300 liters of resin per cubic meter of wastewater.

32. The process of claim 27 including directing an effluent from a petro-chemical plant into a reverse osmosis unit and subjecting the effluent to a reverse osmosis process that produces a concentrate, and wherein the concentrate from the reverse osmosis unit forms the industrial wastewater that is directed into the reactor.
